(19) United States
(12) Patent Application Publication
(10) Pub. No.: US 2026/0320144 A1
(43) Pub. Date: Oct. 15, 2026

(54) SYSTEM AND METHOD FOR AUTOMATING TASKS USING GENERATIVE ARTIFICIAL INTELLIGENCE AND LARGE LANGUAGE MODELS

(71) Applicant: CATALINA MARKETING CORPORATION, St. Petersburg, FL (US)

(72) Inventors: Zubin SINGH, Cupertino, CA (US); Kevin HUNTER, La Jolla, CA (US)

(21) Appl. No.: 19/473,859

(22) PCT Filed: Apr. 11, 2024
(86) PCT No.: PCT/US2024/023982

§ 371 Date: Oct. 9, 2025

Related U.S. Application Data
(60) Provisional application No. 63/459,445, filed on Apr. 14, 2023.

(51) Int. Cl. G06F 16/9538; G06F 9/54

(52) U.S. Cl. CPC G06F 16/9538; G06F 9/547

(57) ABSTRACT

A computer implemented method of the disclosed subject matter includes receiving, in a machine-user chat interface, a task request from a user, identifying, from the task request, a first online resource to perform a first operation in a task and invoking the first online resource and requesting performance of the first operation. The method further includes receiving, from the first online resource, a result of the first operation and providing the result of the first operation to the user.

### CROSS-REFERENCE TO RELATED APPLICATIONS

The present disclosure is related and claims priority under 35 USC § 119(e) to US Provisional Application No. 63/459,445, entitled “SYSTEM AND METHOD FOR AUTOMATING TASKS USING GENERATIVE ARTIFICIAL INTELLIGENCE AND LARGE LANGUAGE MODELS,” filed on Apr. 14, 2023, the contents of which are herein incorporated by reference, in their entirety, for all purposes.

### BACKGROUND

### Technical Field

The present disclosure is directed to artificial intelligence (AI), more specifically, to a system and method for automating tasks using generative AI and large language models (LLM).

### Related Art

LLMs are AI algorithms running on web browsing applications to provide interactive content to users. LLMs are quickly becoming a staple of interactive network transactions today. Currently, most applications use LLMs to provide service such as customer support and advice to the user, via chat applications and the like. Network application plugins have been developed by third-party enterprises offering travel, shopping, search, payment services, and the like, to enhance the range of applicability of LLMs offered by various vendors that allow LLMs to access a corpus of domain-specific information that is not readily available for LLM training purposes across the world-wide-web. While third-party enterprises have the ability to create plugins for LLM platforms, LLM applications currently are not configured to allow a user to direct any general task and perform the task automatically to completion.

### SUMMARY

The subject technology is directed to a system and method for automating tasks using generative AI and LLMs for performing automatic user designed tasks via a network-based AI driven LLM interacting with network users by machine-user chats.

An aspect of the subject technology is directed to A computer implemented method that includes receiving, in a machine-user chat interface, a task request from a user, identifying, from the task request, a first online resource to perform a first operation in a task and invoking the first online resource and requesting performance of the first operation. The method further includes receiving, from the first online resource, a result of the first operation and providing the result of the first operation to the user.

Another aspect of the disclosure is related to a computer implemented method including training a model for task execution including identifying, from a user input in a machine-user chat interface, a request to execute a task and selecting, using the model for task execution, one or more operations for execution in the task. The method further includes identifying at least one online resource to execute each of the one or more operations, collecting, from the at least one online resource, a result of the task and training the model for task execution based on the result of the task.

Yet another aspect of the disclosure is related to a system comprising a first server that includes a chat engine configured to receive a user input from a user and a communication module configured to communicate with one or more other servers. The chat engine includes an LLM tool configured to receive the user input from a user interface of a client device. The user input includes a defined task to be completed by the first server, and the LLM tool is configured to use the one or more other servers as slave servers to completer the defined task.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram illustrating an example of a network architecture to implement embodiments as disclosed herein.

FIG. 2 is a schematic diagram illustrating more details of various devices in the network architecture of FIG. 1.

FIG. 3 is a flow diagram illustrating an exemplary flow of interchange between a chat engine and a user requesting a task execution, according to some aspects of the subject technology.

FIG. 4 is a flow diagram illustrating an example of a method for executing a task upon request by a user via a machine-user chat interface, according to some aspects of the subject technology.

FIG. 5 is a flow diagram illustrating an example of a method of training a task execution model in a machine-user chat engine, according to some aspects of the subject technology.

In the figures, elements having the same or similar reference numerals are associated with the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure. Embodiments as disclosed herein will be described with the description of the attached figures.

### General Overview

Currently, there is an enormous number of online resources available via an internet connection. At the same time, the availability of LLM tools enable network platforms to perform highly coherent and responsive machine-user chats. Accordingly, it is desirable to have a centralized engine that is capable of automating any given task that an online user requests over a machine-user chat. Methods and systems as disclosed herein provide a task execution tool installed in the chat engine and have access to innumerable online resources via plugins, or simply by text recognition and identification of salient points or keywords. Users may have the control of the task performance before, during, and after the task is completed (e.g., via reports and data analysis provided, e.g., by an online resource).

In some implementations, a disclosed machine-user chat interface receives a task request from a user and identifies from the task request, a first online resource to perform a first operation in a task. The machine-user chat interface invokes the first online resource, requests from the first online resource performance of the first operation, receives a result of the first operation and provides the result of the first operation to the user.

In one or more implementations, a model is trained for a task execution including identifying, from a user input in a machine-user chat interface, a request to execute a task. The model selects for task execution, one or more operations in the task for execution. The model further identifies at least one online resource to execute each of the one or more operations and collects, from the online resource, a result of the task. Finally, the model is trained for task execution based on the result of the task.

In some implementations, a system of the subject technology includes a first server that includes a chat engine capable of receiving a user input from a user and a communication module that can communicate with one or more other servers. The chat engine includes an LLM tool that can receive the user input from a user interface of a client device. The user input includes a defined task to be completed by the first server, and the LLM tool can use the other servers as slave servers to completer the defined task.

In one or more implementations, within the machine-user chat interface, a widget for the user enables a task stop and a task pause. A second online resource may be identified to perform a second operation by invoking a second online result to request the second operation including a second parameter from the one or more parameters. Invoking the first online resource is performed by making an API call to a plugin for a server hosting the first online resource. An interaction with an LLM enables providing the parameters for the task.

In some implementations, the task request includes preparing an advertising campaign and the parameters include a product item and one or more advertising channels. The goal may include a pre-selected revenue increase from a periodic purchase of the product item. A request is made for execution of the advertising campaign upon completion of the task. The result of the first operation to the user can be by providing a graphic display of the result in a graphical user interface of a client device with the user. The result of the first operation can be provides to the user via a graphic display of the result in a graphical user interface of a kiosk located in a proximity of the user at a retail store. The first online resource may be instructed to stop the first operation upon request from the user after receiving the result of the first operation. The first online resource may also be instructed to pause the first operation upon request from the user.

In one or more implementations, the result of the first operation may be posted in a third-party social network, per user request. The model used for the execution of the task is a neural network model. The operations for execution of the task can be selected by identifying a classifier for each of the operations. The classifier may include a semantic context of a keyword caption of the task, the parameters, and the goal. The model is trained for task execution by embedding the result of the task and the goal as two vectors in a multi-dimensional space and finding a cosine distance between the two vectors.

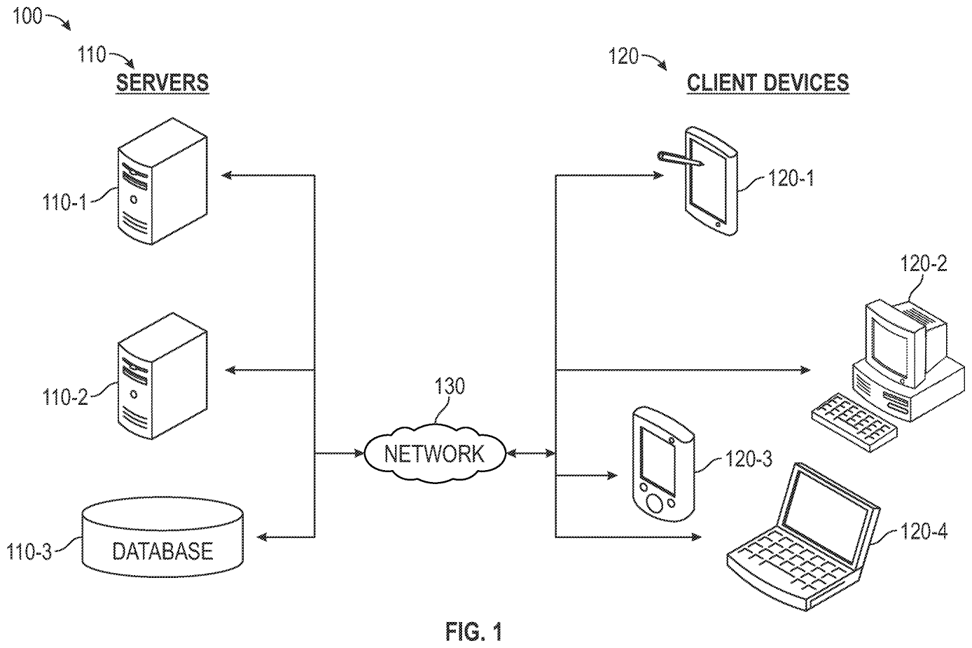

FIG. 1 is a schematic diagram illustrating an example of a network architecture 100 to implement embodiments as disclosed herein. The network architecture 100 may include a plurality of servers 110 communicatively coupled with client devices 120 accessible by the users, and with one or more databases including user information, via a network 130. The network 130 can include, for example, any one or more of a local area network (LAN), a wide area network (WAN), the Internet, and the like. Further, the network 130 can include, but is not limited to, any one or more of the following network topologies, including a bus network, a star network, a ring network, a mesh network, a star-bus network, tree or hierarchical network, and the like.

The servers 110 may include application servers 110-1 hosting LLM engines, retailer servers 110-2 hosting retail applications where consumers can shop and search for consumer packaged goods (CPGs), or any other server hosting a network for providing online services, consumer goods, advertisement payloads, advertising campaigns, digital promotions, incentives, deal payloads, and information (e.g., provided by a travel agency, an airline, a news outlet, a multimedia streaming service, a market report service, an encyclopedia, or a search engine). The servers 110 may include a digital promotion engine to prepare advertisement payloads, an impressions engine to measure consumer impressions of advertisements, and an ad campaign engine to plan advertisement campaigns via different media channels. The servers 110 also include one or more database 110-3. The databases 110-3 may include various data, for example, CPGs information such as vendors lists, price lists, relevant images, and the like, online services information such as information related to the consumer goods, advertisement payloads, advertising campaigns, digital promotions, incentives, deal payloads, and the like.

The client devices 120 may include a mobile device such as a smart phone 120-1, a palm or tablet device 120-3, a laptop 120-4, and the like, a desktop computer 120-2, and the like. The users of the client devices 120 may include consumers in a retail or advertisement network, or users of a browser or web-based application. In some embodiments, the users of the client devices 120 may be administrators or other technical staff of a first server (e.g., retailer servers 110-2) connecting to the first server for maintenance, updates, or to a third-party server for installing a new plugin in application programming interface (API) layers in a third-party server. The client devices 120 may include an “audience” for advertisement payloads provided by an advertisement server. The users of the client devices 120 may include a list of individual anonymized IDs representing a specific characteristic of the market that can be used to activate a marketing campaign (e.g., a consumer segment).

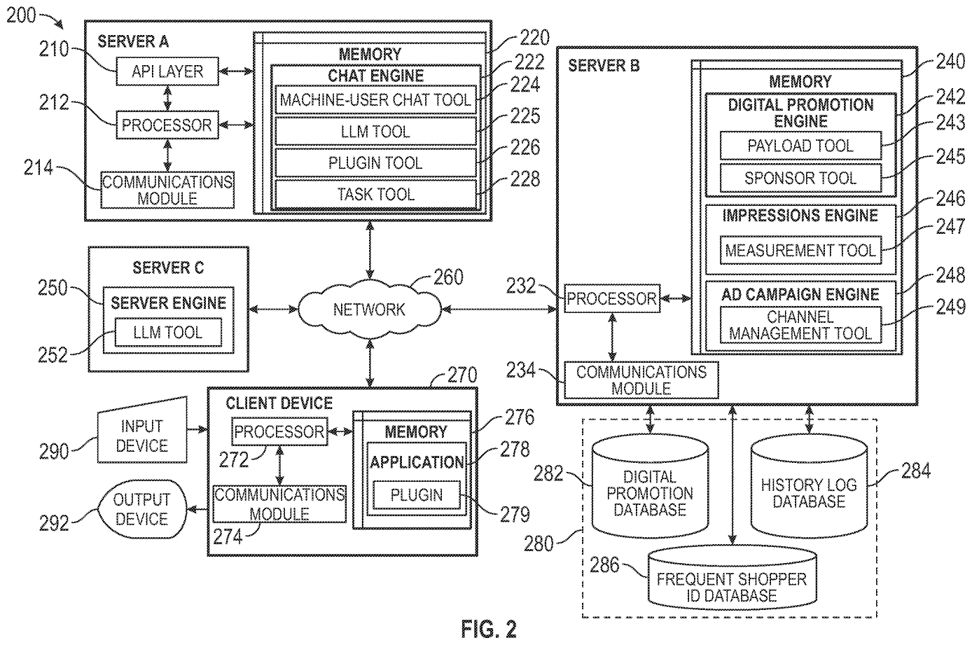

FIG. 2 is a schematic diagram illustrating a system 200 including various devices in the network architecture of FIG. 1. The system 200 includes servers A, B, and C (hereinafter, collectively referred to as “servers”) that are communicatively coupled with a client device 270 and one or more databases 280 (e.g., a digital promotion database 282, a history log database 284, and frequent shopper ID database 286, hereinafter, collectively referred to as “databases 280”), via a network 260, through a communications module (e.g., 214, 234 and 274), as disclosed herein. Each of the servers A, B and C, the client device 270, and the databases 280 may include a memory circuit (e.g., 220, 240, 276) storing instructions and one or more processors (e.g., 210, 232, 252 and 272) to execute the instructions and cause the devices to perform one or more operations in a method as disclosed herein.

Server A includes an application program interface (API) layer 210, processor 212, communication module 214, memory 220, and chat engine 222. The chat engine 222 includes a machine-user chat tool 224, an LLM tool 225, a plugin tool 226 and a task tool 228, as described herein. Server B includes memory 240 including a digital promotion engine 242, an impression engine 246 and an advertisement-(AD-) campaign engine 248. The digital promotion engine 242 includes a payload tool 243 and a sponsor tool 245. The impressions engine 246 includes a measurement tool 247 and the AD-campaign engine 248 includes a channel management tool 249. Server C includes a service engine 250 consisting of an LLM tool 252.

The client device 270 includes processor 272, communication module 274 and memory 276. The memory 276 includes an application 278 that contains a plugin 279. The client device 270 receives user inputs through an input device 290 and provides outputs to the user via an output device 292.

Server A hosts a cloud-based machine-user chat application running in the client device 270 chatting with a user via the chat engine 222 that interfaces with an LLM tool 225 hosting an LLM model. In some embodiments, the LLM includes a neural network with many parameters (typically billions of weights or more), trained on large quantities of unlabeled text using self-supervised learning. The machine-user chat tool 224 can interface with the LLM tool 225 and the plugin tool 226 that enables third-party enterprises to provide the plugin for Server B via the API layer 210. The plugin tool 226 is embedded in the memory 220 of server A, or in the client device 270 (e.g., plugin 279) per user request to server A. In some embodiments, server A may suggest the user to invoke the plugin 279 to the application 278 running in the client device 270 based on a query provided by the user during the interactive query or chat session. These plugins enable the chat engine 222 to interact with APIs defined by developers (cf. API layer 210), enhancing the chat engine capabilities and allowing it to perform a wide range of actions and access multiple resources from the third-party applications. For example, plugins allow a chat engine to retrieve real-time information (e.g., sports scores, stock prices, the latest news, and the like) and incorporate that information into the chat. Plugins can also retrieve knowledge-based information such as company documents, personal notes, and the like. In some embodiments, a plugin can perform actions on behalf of the user, within the chat, for example, book a flight, order food, find a store for purchasing consumer packaged goods (CPGs), or provide coupons and purchase incentives for CPGs.

In some embodiments, an LLM tool is an AI model that acts as an intelligent API caller. Given an API specification and a natural-language description of when to use the API, the LLM proactively calls the API to perform actions.

In some embodiments, the user may specify a task to be performed, via a prompt in the machine-user chat tool 224. The prompt can be entered in as a text to feed into an LLM or more generically a user interface can be provided for the user, through the output device 292, to select a specific defined task across a variety of client devices such as kiosks, smart watches, smart phones, tablets, smart TVs, gaming consoles, digital out-of-home displays, and the like. The task tool 228 of the chat engine 222 in Server A acts as the primary controller or ‘master,’ throughout the performance of the task.

Server A may sequentially or parallelly invoke the same or other instances of sub LLMs (‘slaves’) to perform outstanding jobs to achieve a desired outcome. These slave LLMs or tools (e.g., 252) may be hosted by the service engine 250 in server C. In addition, server A may invoke third-party integrated plugins (slaves) to perform one or more of the jobs sequentially or parallelly, such as the digital promotion engine 242 in server B. Servers B and C report back status to server A during and when the job has completed. Server A keeps track of the status of the jobs that are sanctioned to be completed and communicates back to the user a summary of all jobs completed including references to each sub LLM and plugin for trackability and accountability.

Server A can present the completed task to the client device 270 with the user. The client device 270 may include a variety of devices such as in-store kiosks, smart watches, smart phones, tablets, smart TVs, gaming consoles, digital out-of-home displays, and the like. The client device 270 may be running a machine-user chat application hosted by server A and include input/output devices (e.g., 290/292) such as touchscreen displays, microphones, speakers, pointers, a mouse, a keyboard, and the like. The user can override the workflow of tasks (pause, stop, or select a third-party plugin of their choice) at any point during the chat. Moreover, a third-party server may provide reports and analytics charts for the user, upon task completion. These third-party servers may be invoked by server A, upon request by the user, or automatically, based on chat context.

In some embodiments, the task specified by the user in the machine-user chat with Server A may be to design, prepare, launch, and/or conduct an advertising campaign for a product of interest. Accordingly, Server A may activate a plugin to server B, which has the digital promotion engine 242. Server B may be associated with a domain specific application such as a retail store providing consumers access to their product catalogues, coupons, offers, value added incentives, promotions, and the like. In some embodiments, Server B may be a brand advertisement agency configured to provide advertisement payloads to consumers upon request by a retailer store or branch, or by a brand manufacturer (e.g., in the context of an advertising campaign). In some embodiments, server B may service a consumer network linking consumers to retailers and advertisers. Server B may be linked to the digital promotion database 282, the history log database 284 (e.g., consumer purchasing history), and to the frequent shopper ID database 286. The frequent shopper ID database 286 may link a consumer with one or more retail stores that they subscribe to, and from which they may receive coupons, offers, and value-added incentives based on prior purchasing history. The digital promotion engine 242 of server B has access to the payload tool 243 and the sponsor tool 245.

Payload tool 243 generates an advertisement payload including digital files such as pictures or short videos, including advertisements for selected items or products. The payload tool 243 includes creatives in a digital payload provided to users. A creative includes a digital file (e.g., a picture, a gif, a video, a thumbnail, or an audio snippet) describing a product, service, or consumer item that is promoted. In some embodiments, the payload tool 243 generates a carrousel including multiple advertisements, offers, coupons, and other value-added certificates that the recipient can browse through and select. In some embodiments, the advertisements include sponsored advertisements wherein a retailer or brand manufacturer pays to server B for inclusion in the advertisement payload. In addition to the digital promotion engine 242, server B may also include the impressions engine 246 having the measurement tool 247, to obtain a value for the effectiveness of an advertisement campaign via a machine-user chat channel, and other channels used in an advertisement campaign.

The measurement tool 247 counts advertisement impressions on the user. An impression is an event that includes a placement of a creative in front of the user's eyes, and its context (e.g., channel, publisher, time and date, to whom). The measurement tool 247 is configured to measure an advertisement reach. The advertisement reach includes a count of deduplicated individuals or households that are reached as part of a campaign. The measurement tool 247 may also determine a frequency of the advertisement payload, which includes the average number of times a specific consumer or household is served an impression.

The AD campaign engine 248, including the channel management tool 249, cooperates with the impressions engine 246 to assess the effectiveness of each channel in delivering advertisement payloads via different channels. For example, the AD campaign engine 248 may determine optimal times, seasons, product items, and consumer segments to provide advertisement payloads through the different channels available (e.g., chat, plugin, mobile, browser, and the like).

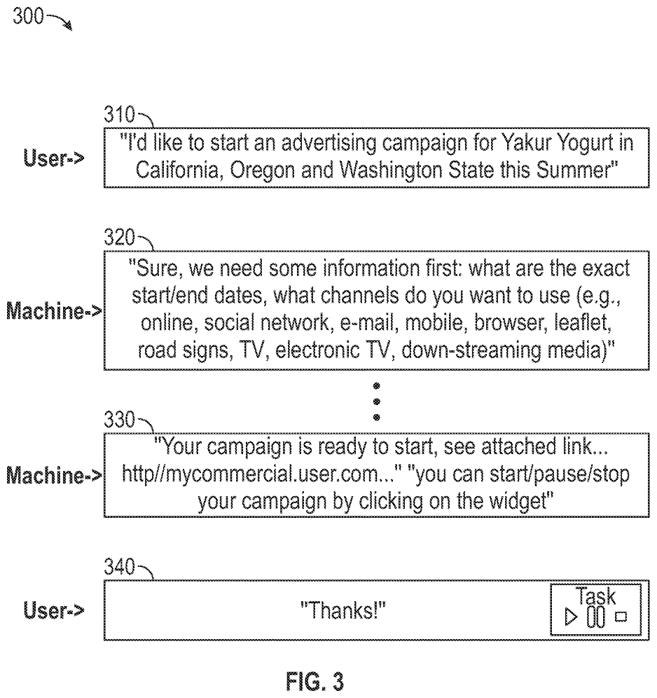

FIG. 3 is a flow diagram illustrating an exemplary flow 300 of interchange between a chat engine (e.g., 222 of FIG. 2) and a user requesting a task execution, according to some aspects of the subject technology. The flow 300 starts with a step 310, where the user begins with an input such as “I'd like to start an advertising campaign for Yakur Yogurt in California, Oregon and Washington State this Summer.” In a next step 320, the chat engine 222 responds “Sure, we need some information first: what are the exact start/end dates, what channels do you want to use (e.g., online, social network, e-mail, mobile, browser, leaflet, road signs, TV, electronic TV, down-streaming media).” After a few more similar exchanges, in a step 3330, the chat engine 222 responds “your campaign is ready to start, see attached link,” and “you can start/pause/stop your campaign by clicking on the attached widget.” Finally, in a step 340, the chat engine, provides a widget in the user chat-box with which the user can control the execution of the requested task.

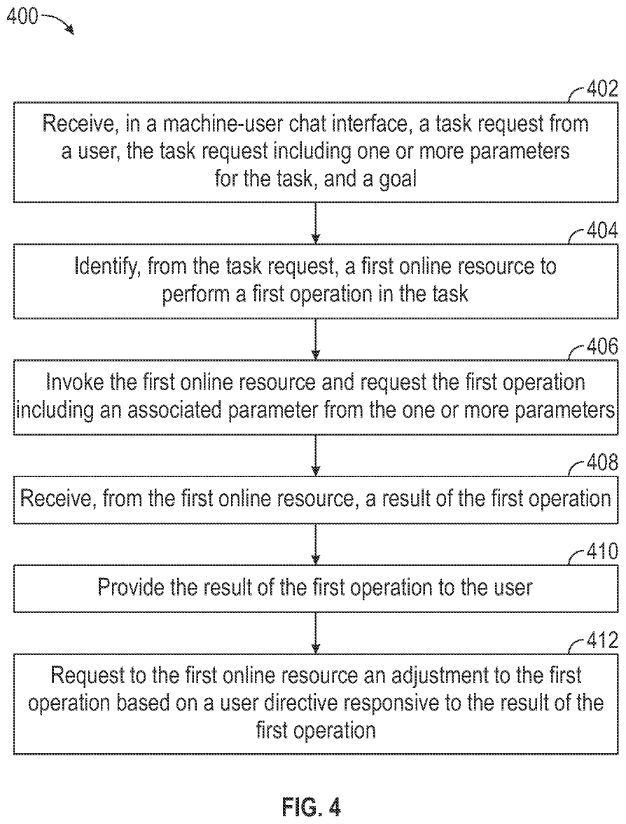

FIG. 4 is a flow diagram illustrating an example of a method 400 for executing a task, upon a request by a user (e.g., of the client device 270 of FIG. 2), via a machine-user chat interface, according to some aspects of the subject technology. In some embodiments, one or more of the steps in method 400 may be performed by a processor circuit (e.g., 212 of FIG. 2) executing instructions stored in a memory circuit (e.g., 220 of FIG. 2) in any of one or more servers (e.g., server A of FIG. 2), a client device (e.g., 270 of FIG. 2) or a database (e.g., any of databases 280 of FIG. 2), as disclosed herein. Moreover, the one or more servers (e.g., server A) may include a chat engine (e.g., 222 of FIG. 2) operating a machine-user chat tool (e.g., 224 of FIG. 2), an LLM tool (e.g., 225 of FIG. 2), a plugin tool (e.g., 226 of FIG. 2), and a task tool (e.g., 228 of FIG. 2), as disclosed herein. The one or more servers (e.g., server B of FIG. 2) may also include a digital promotion engine (e.g., 242 of FIG. 2) having a payload tool (e.g., 243 of FIG. 2) and a sponsor tool (e.g., 245 of FIG. 2), an impressions engine (e.g., 246 of FIG. 2) having a measurement tool (e.g., 247 of FIG. 2), and an AD campaign engine (e.g., 248 of FIG. 2) having a channel management tool (e.g., 249 of FIG. 2), as disclosed herein. Methods consistent with the present disclosure may include at least one or more steps in method 400 performed in a different order, simultaneously, quasi-simultaneously, or overlapping in time.

Step 402 includes receiving, in a machine-user chat interface (e.g., of 224 of FIG. 2), a task request from a user via a client device (e.g., 270 of FIG. 2). The task request may include one or more parameters for a task, and a goal.

Step 404 includes identifying, (e.g., by the task tool 228 of FIG. 2) from the task request, a first online resource (e.g., processor 232 of FIG. 2) to perform a first operation in the task. In some embodiments, step 404 includes identifying a second online resource to perform a second operation and invoking a second online result to request the second operation including a second parameter from the one or more parameters.

Step 406 includes invoking the first online resource and requesting the first operation including an associated parameter from the one or more parameters. In some embodiments, step 406 further includes providing, within the machine-user chat interface (e.g., of 224 of FIG. 2), a widget for the user to enable a task stop and a task pause. In some embodiments, step 406 includes making an AP layer (e.g., 210 of FIG. 2) interface call to a plugin for a server hosting the first online resource, and interacting with a large language model (e.g., via LLM tool 225 of FIG. 2) therein, to provide the one or more parameters for the task. In some embodiments, step 406 includes preparing an advertising campaign (e.g., via AD campaign engine 248 of FIG. 2), the one or more parameters include a product item, and at least one advertising channel, and the goal includes a pre-selected revenue increase from a periodic purchase of the product item. In some embodiments, step 406 further includes requesting execution of the advertising campaign upon completion of the task.

Step 408 includes receiving, from the first online resource, a result of the first operation. In some embodiments, the results may include, but is not limited to, a digital payload such as creatives including a digital file (e.g., a picture, a gif, a video, a thumbnail, or an audio snippet) describing a product, service, or consumer item that is promoted. In some embodiments, the digital payload includes a carrousel including multiple advertisements, offers, coupons, and other value-added certificates that the recipient can browse through and select.

Step 410 includes providing the result of the first operation to the user via an output device (e.g., 292 of FIG. 2). In some embodiments, step 410 includes providing a graphic display of the result in a graphical user interface of the client device 270 with the user. In some embodiments, step 410 includes providing a graphic display of the result in a graphical user interface of a kiosk located in a proximity of the user at a retail store. In some embodiments, step 410 includes instructing the first online resource to stop the first operation upon request from the user after providing the result of the first operation.

Step 412 includes requesting to the first online resource an adjustment to the first operation based on a user directive responsive to the result of the first operation. In some embodiments, step 412 includes instructing the first online resource to pause the first operation upon request from the user after providing the result of the first operation. In some embodiments, step 412 further includes posting the result of the first operation in a third-party social network, per user request.

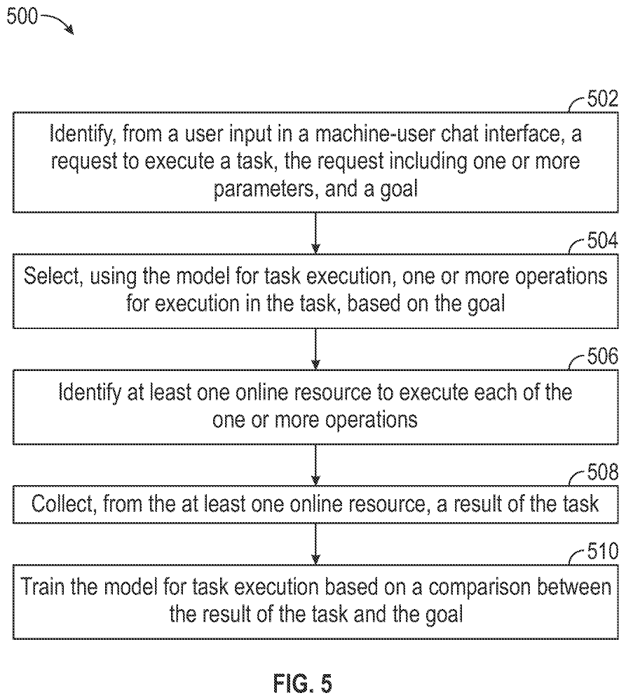

FIG. 5 is a flow diagram illustrating an example of a method 500 of training a task execution model in a machine-user chat engine (e.g., 222 of FIG. 2), according to some aspects of the subject technology. In some embodiments, one or more of the steps in method 500 may be performed by a processor circuit (e.g., 212 of FIG. 2) executing instructions stored in a memory circuit (e.g., 220 of FIG. 2) in any of one or more servers ((e.g., server A of FIG. 2), a client device (e.g., 270 of FIG. 2) or a database (e.g., any of 280 of FIG. 2), as disclosed herein. Moreover, the one or more servers (e.g., server A of FIG. 2) may include a chat engine (e.g., 222 of FIG. 2) operating a machine-user chat tool (e.g., 224 of FIG. 2), an LLM tool (e.g., 225 of FIG. 2), a plugin tool (e.g., 226 of FIG. 2), and a task tool (e.g., 228 of FIG. 2), as disclosed herein. The one or more servers (e.g., server B of FIG. 2), may also include a digital promotion engine (e.g., 242 of FIG. 2) having a payload tool (e.g., 223 of FIG. 2), and a sponsor tool (e.g., 247 of FIG. 2), an impressions engine (e.g., 226 of FIG. 2) having a measurement tool (e.g., 224 of FIG. 2), and an AD campaign engine (e.g., 248 of FIG. 2) having a channel management tool (e.g., 249 of FIG. 2), as disclosed herein. Methods consistent with the present disclosure may include at least one or more steps in method 500 performed in a different order, simultaneously, quasi-simultaneously, or overlapping in time.

Step 502 includes identifying, from a user input received, via an input device (e.g., 290 of FIG. 2), in a machine-user chat interface, a request to execute a task, the request including a one or more parameters, and a goal.

Step 504 includes selecting, using a model (e.g., an LLM) for task execution, one or more operations for execution in the task, based on the goal.

In some embodiments, the model for task execution is a neural network model. In some embodiments, step 504 further includes identifying a classifier for each of the one or more operations. The classifier includes a semantic context of a keyword caption of the task, the one or more parameters, and the goal.

Step 506 includes identifying at least one online resource (e.g., processor 212 of FIG. 2) to execute each of the one or more operations.

Step 508 includes collecting, from the at least one online resource, a result of the task.

Step 510 includes training the model for task execution based on a comparison between the result of the task and the goal.

In some embodiments, step 510 includes embedding the result of the task and the goal as two vectors in a multi-dimensional space and finding a cosine distance between the two vectors.

In some aspects, the word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.” While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking system. It should be noted that the subject technology enables fabrication of a depth-sensing apparatus that is a fully solid-state device with small size, low power, and low cost.

To the extent that the term “include,” “have,” or the like is used in the description or the claims, such term is intended to be inclusive in a manner similar to the term “comprise” as “comprise” is interpreted when employed as a transitional word in a claim.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

What is claimed is:

1. A computer implemented method, comprising:
receiving, in a machine-user chat interface, a task request from a user;
identifying, from the task request, a first online resource to perform a first operation in a task;
invoking the first online resource and requesting performance of the first operation;
receiving, from the first online resource, a result of the first operation; and
providing the result of the first operation to the user.

2. The computer implemented method of claim 1, further comprising receiving a user directive responsive to the result of the first operation.

3. The computer implemented method of claim 2, further comprising requesting the first online resource an adjustment to the first operation based on the user directive.

4. The computer implemented method of claim 1, wherein the task request comprises one or more parameters for a task, and a goal, and wherein the first operation comprises using a first parameter from the one or more parameters.

5. The computer implemented method of claim 4, further comprising identifying a second online resource to perform a second operation and invoking a second online resource to request performance of the second operation including a second parameter from the one or more parameters.

6. The computer implemented method of claim 4, wherein invoking the first online resource comprises:
making an application programming interface (API) call to a plugin for a server hosting the first online resource; and
interacting with an associated large language model (LLM) to provide the one or more parameters for the task.

7. The computer implemented method of claim 1, further comprising providing, within the machine-user chat interface, a widget for the user to enable a task stop and a task pause.

8. The computer implemented method of claim 1, wherein providing the result of the first operation to the user comprises providing a graphic display of the result in a graphical user interface of a kiosk located in a proximity of the user at a retail store.

9. The computer implemented method of claim 1, further comprising instructing the first online resource to stop the first operation upon a first request from the user after providing the result of the first operation.

10. The computer implemented method of claim 9, further comprising instructing the first online resource to pause the first operation upon a second request from the user after providing the result of the first operation.

11. The computer implemented method of claim 9, further comprising posting the result of the first operation in a third-party social network upon a third request from the user.

12. A computer implemented method, comprising:
training a model for task execution including identifying, from a user input in a machine-user chat interface, a request to execute a task;
selecting, using the model for task execution, one or more operations for execution in the task;
identifying at least one online resource to execute each of the one or more operations;
collecting, from the at least one online resource, a result of the task; and
training the model for task execution based on the result of the task.

13. The computer implemented method of claim 12, wherein the request comprises one or more parameters, and a goal, and wherein the task execution is based on the goal.

14. The computer implemented method of claim 13, wherein the training is based on a comparison between the result of the task and the goal.

15. The computer implemented method of claim 14, wherein training the model for task execution comprises embedding the result of the task and the goal as two vectors in a multi-dimensional space and finding a cosine distance between the two vectors.

16. The computer implemented method of claim 14, wherein the model for task execution is a neural network and selecting the one or more operations for execution comprises identifying a classifier for each of the one or more operations.

17. The computer implemented method of claim 16, wherein the classifier includes a semantic context of a keyword caption of the task, the one or more parameters, and the goal.

18. A system, comprising:
a first server including a chat engine configured to receive a user input from a user; and
a communication module configured to communicate with one or more other servers; and
wherein:
the chat engine includes a large language model (LLM) tool configured to receive the user input from a user interface of a client device, the user input includes a defined task to be completed by the first server, the LLM tool is configured to use the one or more other servers as slave servers to completer the defined task.

19. The system of claim 18, wherein the LLM tool is configured to invoke LLM tools of the slave servers to use the slave servers for completion of the defined task either sequentially or parallelly.

20. The system of claim 19, wherein the LLM tool is configured to receive status from the invoked LLM tools of the slave servers; and present a completed task to the user via the client device; and wherein the client device comprises at least one of a smart phone, a smart watch, a tablet, a smart television, a game console, a kiosk, a digital out-of-home display.
